(19) United States
(12) Patent Application Publication
(10) Pub. No.: US 2022/0309646 A1
(43) Pub. Date: Sep. 29, 2022

(54) ACQUISITION APPARATUS, ACQUISITION SYSTEM AND ACQUISITION METHOD

(71) Applicant: CHANGXIN MEMORY TECHNOLOGIES, INC., Hefei City (CN)

(72) Inventors: YUI-LANG CHEN, Hefei City (CN); CHING-FENG CHEN, Hefei City (CN)

(21) Appl. No.: 17/648,150

(22) Filed: Jan. 17, 2022

Related U.S. Application Data
(63) Continuation of application No. PCT/CN2021/113304, filed on Aug. 18, 2021.

(30) Foreign Application Priority Data
Mar. 26, 2021 (CN) 2021103628197.1

(51) Int. Cl. G06T 7/00; H04N 5/225; H04N 5/232

(52) U.S. Cl. CPC G06T 7/0004; H04N 5/2256; H04N 5/2253; H04N 5/23206

(57) ABSTRACT

Embodiments of the present application are applied in the field of semiconductor inspection, and provide an acquisition apparatus, an acquisition system and an acquisition method. The acquisition apparatus includes: a base and a core plate, the core plate being configurated to carry a chip tray; a first support portion, being disposed on the base and connected with a first camera assembly, and the first camera assembly being disposed above the core plate; and a second support portion, being disposed on the base and connected with a second camera assembly, and the second camera assembly being disposed above the core plate; wherein the first camera assembly is configurated to capture an image of a first region of the chip tray, the second camera assembly is configurated to capture an image of a second region of the chip tray.

### CROSS-REFERENCE TO RELATED APPLICATIONS

The present application is a continuation application of International Patent Application No. PCT/CN2021/113304, titled “ACQUISITION APPARATUS, ACQUISITION SYSTEM AND ACQUISITION METHOD” and filed on Aug. 18, 2021, which claims the priority to Chinese Patent Application 202110328197.1, titled “ACQUISITION APPARATUS, ACQUISITION SYSTEM AND ACQUISITION METHOD” and filed on Mar. 26, 2021. The entire contents of International Patent Application No. PCT/CN2021/113304 and Chinese Patent Application 202110328197.1 are incorporated herein by reference.

### TECHNICAL FIELD

The present application relates to the field of semiconductor inspection, and in particular, to an acquisition apparatus, an acquisition system and an acquisition method.

### BACKGROUND

During the manufacturing of a semiconductor, chips on a chip tray are mainly calibrated and identified by obtaining codes of the chips, and the codes of the chips need to be acquired by an expensive laser camera. However, the laser camera has a small image capturing range, and cannot obtain the codes of all the chips in the chip tray by single acquisition.

At present, the laser camera is mainly manually controlled to code and acquire the chips on the chip tray. However, there are a lot of chips on the chip tray, and the acquisition of codes of all the chips in the chip tray requires multiple times of shooting by the laser camera, which takes a lot of inspection time and is not conducive to the batch production of chips. In addition, the manual operation is prone to problems such as missing acquisition, repeated acquisition and wrong position and sequence acquisition of chips.

Therefore, how to obtain the codes of all the chips on the chip tray in a single shot of the chip tray is an urgent problem to be solved in the semiconductor manufacturing process.

### SUMMARY

An embodiment of the present application provides an acquisition apparatus, including: a base and a core plate disposed on the base, the core plate being configurated to carry a chip tray; a first support portion, the first support portion being disposed on the base and connected with a first camera assembly, and the first camera assembly being disposed above the core plate; and a second support portion, the second support portion being disposed on the base and connected with a second camera assembly, and the second camera assembly being disposed above the core plate; wherein the first camera assembly is configurated to capture an image of a first region of the chip tray, the second camera assembly is configurated to capture an image of a second region of the chip tray, and a sum of the first region and the second region covers an entire region of the chip tray.

An embodiment of the present application further provides an acquisition system, including: the above-mentioned acquisition apparatus, a control converter, a storage database, an interactive server and a terminal; the acquisition apparatus is configured to acquire an image of the chip tray; the control converter is in communication connection with the acquisition apparatus, and is configured to set configuration information for the acquisition apparatus according to a control command, obtain the image of the chip tray, obtain data information from the image of the chip tray, and upload the data information to the storage database; the storage database is in communication connection with the control converter, and is configured to update data based on the control command, transmit the control command to the control converter, and store the data information; the interactive server is in communication connection with the storage database, and is configured to upload the received control command to the storage database, search corresponding data information in the storage database based on the control command, and transmit the data information to the terminal; and the terminal is in communication connection with the interactive server, and is configured to issue the control command to the interactive server based on an operator instruction and display the data information transmitted by the interactive server.

An embodiment of the present application further provides an acquisition method, including: a terminal receiving an operator instruction, and issuing a control command to an interactive server based on the operator instruction; the interactive server uploading the received control command to a storage database; the storage database updating data based on the control command, and transmitting the control command to a control converter; the control converter setting configuration information for an acquisition apparatus according to the control command; the acquisition apparatus acquiring an image of a chip tray according to the configuration information; the control converter obtaining data information from the image of the chip tray, and uploading the data information to the storage database; the storage database storing the data information; the interactive server searching corresponding data information in the storage database according to the control command, and transmitting the data information to the terminal; and the terminal displaying the data information transmitted by the interactive server.

### BRIEF DESCRIPTION OF THE DRAWINGS

FIG. 1 is a schematic structure diagram of an acquisition apparatus provided by an embodiment of the present application;

FIG. 2 is a schematic diagram of shooting regions of a first camera assembly and a second camera assembly in the acquisition apparatus provided by an embodiment of the present application;

FIG. 3 is a schematic principle diagram of the acquisition apparatus provided by an embodiment of the present application;

FIG. 4 is an another schematic structure diagram of the acquisition apparatus provided by an embodiment of the present application;

FIG. 5 is a schematic structure diagram of an acquisition system provided by another embodiment of the present application;

FIG. 6 is a schematic flowchart of an acquisition method provided by another embodiment of the present application.

### DETAILED DESCRIPTION

At present, a laser camera is mainly manually controlled to code and acquire chips on a chip tray. However, there are a lot of chips on the chip tray, and the acquisition of codes of all the chips in the chip tray requires multiple times of shooting by the laser camera, which takes a lot of inspection time and is not conducive to the batch production of chips. In addition, the manual operation is prone to problems such as missing acquisition, repeated acquisition and wrong position and sequence acquisition of chips.

An embodiment of the present application provides an acquisition apparatus, including: a base and a core plate disposed on the base, the core plate being configurated to carry a chip tray; a first support portion, the first support portion being disposed on the base and connected with a first camera assembly, and the first camera assembly being disposed above the core plate; and a second support portion, the second support portion being disposed on the base and connected with a second camera assembly, and the second camera assembly being disposed above the core plate; wherein the first camera assembly is configurated to capture an image of a first region of the chip tray, the second camera assembly is configurated to capture an image of a second region of the chip tray, and the sum of the first region and the second region covers the entire region of the chip tray.

A person of ordinary skill in the art can understand that, in each embodiment of the present application, many technical details are proposed in order to enable a reader to better understand the present application. However, the technical solutions of the present application can also be implemented without these technical details and various variations and modifications based on the following embodiments.

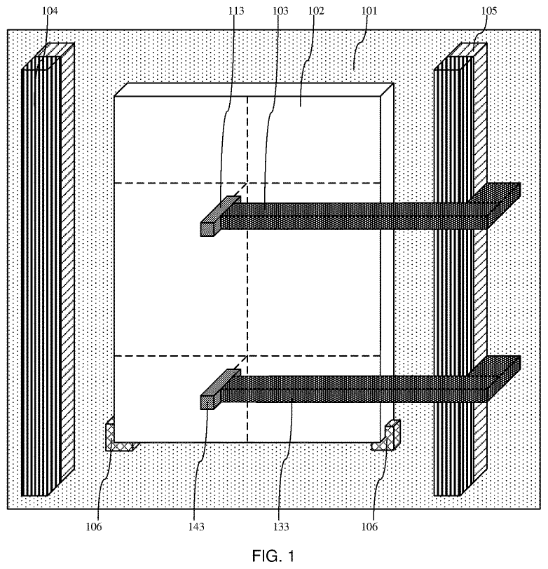

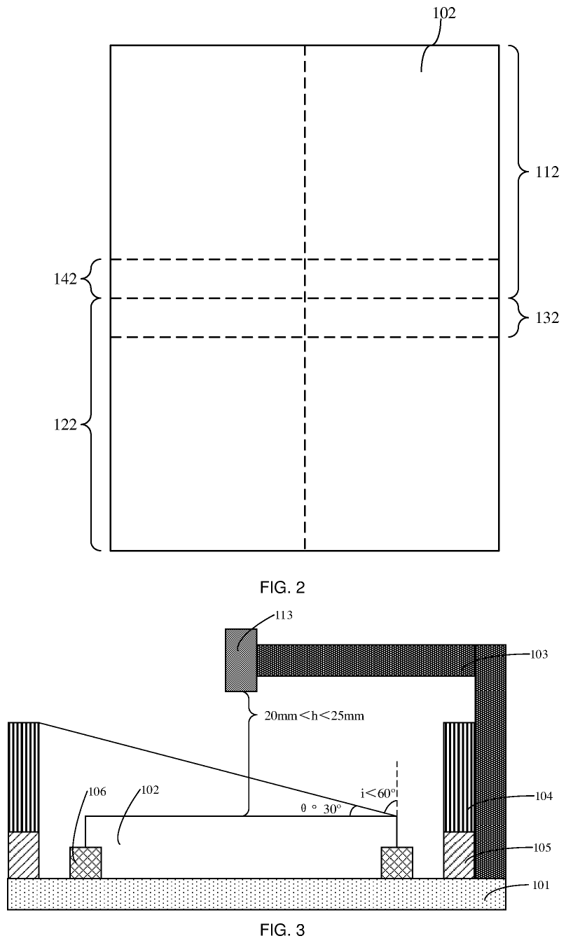

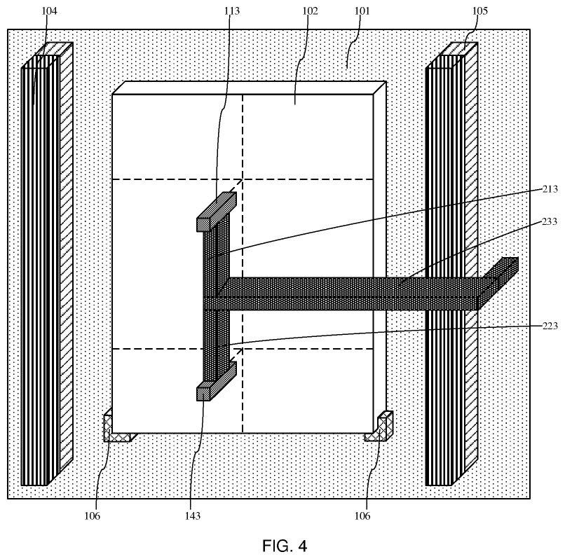

FIGS. 1 and 4 are schematic structure diagrams of an acquisition apparatus provided by this embodiment, FIG. 2 is a schematic diagram of shooting regions of a first camera assembly and a second camera assembly in the acquisition apparatus provided by this embodiment, and FIG. 3 is a schematic principle diagram of the acquisition apparatus provided by this embodiment. The acquisition apparatus provided by this embodiment will be described in further detail below with reference to the accompanying drawings, specifically as follows:

Referring to FIG. 1, the acquisition apparatus includes a base 101 and a core plate 102 disposed on the base 101, the core plate 102 is configurated to carry a chip tray (not shown), chips are placed in the chip tray (not shown), and the chips have codes for the calibration and identification of the chips.

In this embodiment, the length, width, and height of the chip tray (not shown) meet the specifications specified by JEDEC. Specifically, the number of chips placed in the chip tray (not shown) is represented by the number of chips in the length direction×the number of chips in the width direction. 19×11 and 17×8 chips can be placed on the existing standard chip tray (not shown).

In addition, in this embodiment, the core plate 102 is of a rectangular parallelepiped in the same shape as the chip tray (not shown) to ensure that there is no overhanging portion after the chip tray (not shown) is placed on the core plate 102. In other embodiments, the core plate may be in any shape. This embodiment does not limit the shape of the core plate. Those skilled in the art should understand that, no matter in which shape the core plate 102 is, the core plate 102 having the purpose of stably carrying the chip tray (not shown) should fall into the protection scope of the present application.

Further, in order to ensure the stability of the core plate 102 carrying the chip tray (not shown), the core plate 102 is fixed on the base 101.

In an example, the core plate 102 may be fixed on the base 101 by bonding contact surfaces of the core plate 102 and the base 101.

In another example, the acquisition apparatus further includes a positioning assembly (not shown). The positioning assembly (not shown) is fixed on the base 101 and configurated to fix the core plate 102 placed on the base 101. The core plate 102 placed on the base 101 is fixed by the positioning assembly (not shown) fixed on the base 101, which facilitates the disassembly and assembly of the acquisition apparatus while ensuring the stability of the core plate 102.

Specifically, referring to FIG. 1, the positioning assembly (not shown) includes two L-shaped positioning portions 106 arranged oppositely. In this embodiment, the core plate 102 is rectangular, and the positioning portions 106 are attached to two opposite corners of the core plate 102 to fix the core plate 102. In other embodiments, the core plate may be set in any shape, and the positioning portions are arranged to fit the edges or corners of the core plate, so that the core plate can be fixed by the positioning portions.

It should be noted that the positioning portions 106 are not higher than the core plate 102 to prevent the chip tray (not shown) from being partially fixed by the positioning portions 106 so that the chip tray (not shown) is not placed flat.

Further, the base 101 includes a plurality of discrete slots (not shown), and bottoms of the positioning portions 106 are also provided with pins (not shown) that fit the slots. The pins are inserted into the slots to change the positions of the positioning portions 106 fixed on the base 101, so that the acquisition apparatus is suitable for the core plate 102 of different sizes and multiple choices are provided for the fixing position of the core plate 102.

The acquisition apparatus further includes: a first support portion 103 and a second support portion 133; wherein the first support portion 103 is disposed on the base 101 and connected with a first camera assembly 113, and the first camera assembly 113 is disposed above the core plate 102; the second support portion 133 is disposed on the base 101 and connected with a second camera assembly 143, and the second camera assembly 143 is disposed above the core plate 102.

The first camera assembly 113 and the second camera assembly 143 are configurated to capture images of the chip tray (not shown) placed on the core plate 102, and codes of the chips placed in the chip tray (not shown) are identified later through the captured image of the chip tray (not shown).

Specifically, the first camera assembly 113 is configurated to capture an image of a first region of the chip tray (not shown), the second camera assembly is configurated to capture an image of a second region of the chip tray (not shown), and the sum of the first region and the second region cover the entire region of the chip tray (not shown).

Referring to FIG. 2, the first region includes a first sub-region 112 and a third sub-region 132, and the second region includes a second sub-region 122 and a fourth sub-region 142; wherein, the first sub-region 112 and the second sub-region 122 are: in the length direction of the core plate 102, and in the two regions for dividing the core plate 102 equally, the third sub-region 132 is a part of the second sub-region 122 close to the first sub-region 112, and the fourth sub-region 142 is a part of the first sub-region 112 close to the second sub-region 122.

Further, referring to FIG. 1, the first camera assembly 113 and the second camera assembly 143 are respectively located above intersections of two trisectors in the length direction of the core plate 102 and a perpendicular bisector in the width direction of the core plate 102. The first camera assembly 113 and the second camera assembly 143 are symmetrically disposed above the intersections of the two trisectors and the perpendicular bisector, which ensures that the sum of images captured by the first camera assembly 113 and the second camera assembly 143 covers the entire region of the core plate 102.

In an example, referring to FIG. 4, the acquisition apparatus further includes a support rod 233, the support rod 233 is disposed on the base 101, the first support portion 103 includes a first support arm 213, and the first support arm 213 extends in a first direction from the support rod 233 and is connected to the first camera assembly 113; the second support portion 133 includes a second support arm 223, the second support arm 223 extends in a second direction from the support rod 233 and is connected to the second camera assembly 143; wherein, the angle between the first direction and the second direction is greater than 0° and less than 180°.

Based on this example, in a specific application process, the first support arm 213 and the second support arm 223 may also be rotatably disposed on the support rod 233 to change the relative positions of the first camera assembly 113 and the second camera assembly 143. In addition, the support rod 233 may be movably disposed on the base 101 to change the horizontal positions of the first camera assembly 113 and the second camera assembly 143. The movement of the support rod 233 drives the first camera assembly 113 and the second camera assembly 143 to move, so as to change the positions of the first camera assembly 113 and the second camera assembly 143 according to the position of the chip tray (not shown), which ensures that the sum of images captured by the first camera assembly 113 and the second camera assembly 143 covers the entire region of the chip tray (not shown).

It should be noted that both the first camera assembly 113 and the second camera assembly 143 include at least one camera. Specifically, the number of cameras may be determined according to the accuracy of images required in the actual application. The specific number of cameras in the first camera assembly 113 and the second camera assembly 143 is limited.

In addition, referring to FIG. 3, in this embodiment, in the direction perpendicular to the surface of the base 101, the first camera assembly 113 and the second camera assembly 143 are located at the same height, and the first camera assembly 113 is 20 mm to 25 mm, such as 21 mm, 22 mm, 23 mm or 24 mm, away from the top surface of the core plate 102. The heights of the first camera assembly 113 and the second camera assembly 143 ensure that the first camera assembly 113 and the second camera assembly 143 can capture clear images of the chip tray. Preferably, the first camera assembly 113 is 23.5 mm away from the top surface of the core plate 102.

Continuing to refer to FIG. 1, the acquisition apparatus further includes light-emitting assemblies 104 located on the base 101 and on two sides of the core plate 102, and each light-emitting assembly is disposed parallel to the edge of one side of the core plate 102 close to the light-emitting assembly 104. The light-emitting assemblies 104 disposed horizontally prevent light from directly illuminating the codes of the chips, so that the reflectivity of the codes of the chips in the images of the chip tray is relatively high, and the codes of the chips can be identified from the images of the chip tray.

In addition, the acquisition apparatus further includes light-emitting assembly bases 105 located on the base 101 and configurated to carry the light-emitting assemblies 104, and the light-emitting assemblies 104 are disposed on the light-emitting assembly bases. The light-emitting assembly bases 105 carry the light-emitting assemblies 104, so that the light-emitting assemblies 104 are higher than the chip tray (not shown) in the horizontal direction, which prevents part of light from being unable to illuminate the chip tray (not shown), resulting in waste of the light.

Further, referring to FIG. 3, in the direction perpendicular to the surface of the base 101, the height of the light-emitting assembly base 105 satisfies the following condition: the incident angle of the light-emitting assembly 104 toward the edge of one side of the core plate 102 away from the light-emitting assembly is less than 60°. By ensuring the illumination angle of light, relatively high reflectivity of codes of the chips in the images of the chip tray (not shown) is further ensured, and the codes of the chips can be identified from the images of the chip tray (not shown).

Furthermore, in the direction perpendicular to the surface of the base 101, the side without the light-emitting assembly bases 105 is provided with bayonets (not shown) of different heights, the base 101 is also fixed with clamping grooves (not shown) tabled with the bayonets, and the bayonets (not shown) and the clamping grooves (not shown) are configurated to adjust the height differences between the light-emitting assembly bases 105 and the base 101 according to the size of the core plate 102. Through the bayonets (not shown) and the clamping grooves (not shown), the heights of the light-emitting assembly bases 105 can be adjusted according to the height of the chip tray, so that codes of chips in the images of different chip trays can have a relatively high reflectivity, which facilitates the identification of the codes of the chips from the images of the chip tray.

In a specific example, it is assumed that the core plate 102 has a length of t1, a width of t2 and a height of t3. The size of the core plate 102 meets the specifications specified by JEDEC, that is (t1, t2, t3)=(31, 13, 0.8). It is assumed that the light-emitting assembly 104 has a length of l1, a width of l2 and a height of l3, the base 101 has a length of b1, a width of b2 and a height of b3, and the distance between the light-emitting assembly base 105 and the core plate 102 is d0. In order to ensure that the light of the light-emitting assembly 104 illuminates parallel to the core plate 102, that is, b1>l1>t1, the width of the light-emitting assembly 104 is unlimited, l2>0. For the height t3 of the light-emitting assembly, tan θ=(l3+h3−0.8)/(l3+d0)≥tan 30°, where h3 is the height of the light-emitting assembly base 105. It is assumed that the light-emitting assembly base 105 has a length of h1, a width of h2 and a height of h3, then the size of the light-emitting assembly base 105 needs to ensure that it can carry the light-emitting assembly 104, that is, h1=11, h2=12, and h3>0. It is assumed that the positioning portion 106 has a length of g1, a width of g2 and a height of g3. Since the positioning portions 106 are disposed at two adjacent corners of the core plate 102, the positioning portions 106 are not higher than the core plate 102, that is, the two positioning portions 106 are in the same shape, that is, t2/2+g2>g1>0, 1≥g2>0, and t3≥g3>0.

The acquisition apparatus is provided with a core plate and a plurality of camera assemblies, the core plate is configurated to place the chip tray, the camera assemblies are configurated to shoot the chip tray, and the different camera assemblies are configurated to shoot different regions of the chip tray. Since the camera assemblies are configurated to shoot different regions of the chip tray, images of the entire chip tray can be captured in a single shooting process, and then codes of all chips on the chip tray can be acquired, which saves inspection time and is conducive to the batch production of chips.

Another embodiment of the present application relates to an acquisition system, including: the acquisition apparatus in the above embodiment, and a control converter, a storage database, an interactive server and a terminal; the acquisition apparatus is configured to acquire an image of the chip tray; the control converter is in communication connection with the acquisition apparatus, and is configured to set configuration information for the acquisition apparatus according to a control command, obtain the image of the chip tray, obtain data information from the image of the chip tray, and upload the data information to the storage database; the storage database is in communication connection with the control converter, and is configured to update data based on the control command, transmit the control command to the control converter, and store the data information; the interactive server is in communication connection with the storage database, and is configured to upload the received control command to the storage database, search corresponding data information in the storage database, and transmit the data information to the terminal; and the terminal is in communication connection with the interactive server, and is configured to issue the control command to the interactive server based on an operator instruction and display the data information transmitted by the interactive server.

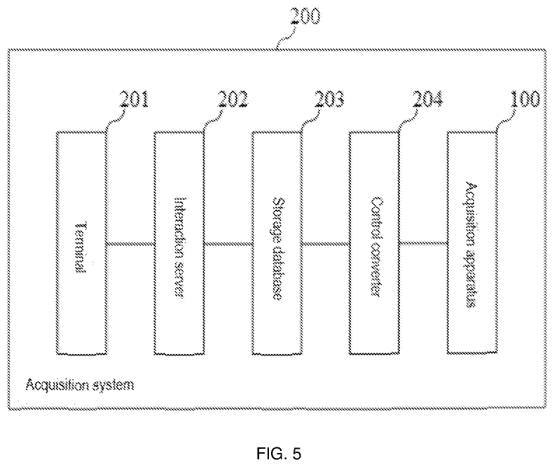

FIG. 5 is a schematic structure diagram of the acquisition system provided by this embodiment. The acquisition system provided by this embodiment will be described in detail below with reference to the accompanying drawing. The parts that are the same as or corresponding to the above embodiment will not be described in detail below.

Referring to FIG. 5, the acquisition system 200 includes: the acquisition apparatus 100 provided in the above embodiment, and a control converter 204, a storage database 203, an interaction server 202 and a terminal 201.

The acquisition apparatus 100 is configured to acquire an image of the chip tray.

Specifically, the acquisition apparatus 100 acquires an image of the chip tray according to configuration information set by the control converter 204.

The control converter 204 is configured to set the configuration information for the acquisition apparatus 100, and obtain chip codes in the image of the chip tray according to the image of the chip tray acquired by the acquisition apparatus 100.

Specifically, the control converter 204 is in communication connection with the acquisition apparatus 100, and is configured to set the configuration information for the acquisition apparatus 100 according to a control command. The control converter 204 is further configured to obtain the image of the chip tray, obtain data information in the image of the chip tray, that is, obtain chip codes in the image of the chip tray, and upload the obtained data information to the storage database.

The storage database 203 is configured to store the control command transmitted to the control converter 204 and chip code data in the image of the chip tray.

Specifically, the storage database 203 is in communication connection with the control converter 204, and is configured to update the data in the storage database 203 according to the control command and transmit the updated control command to the control converter. The storage database 203 is further configured to receive and store the data information uploaded by the control converter 204, that is, store the chip codes obtained by the control converter 204.

The interactive server 202 is configured to receive the control command, transmit the control command to the storage database 203, and query corresponding data information in the storage database 203 according to the control command.

Specifically, the interactive server 202 is in communication connection with the storage database 203, and is configured to upload the received control command to the storage database 203. The interactive server 202 is further configured to search corresponding data information in the storage database 203 according to the control command, that is, obtain data information corresponding to the control command, and transmit the data information to the terminal 201.

The terminal 201 is a personal terminal with communication functions such as a personal computer or a mobile phone, and is configured to generate the control command and display the data information corresponding to the control command.

Specifically, the terminal 201 is in communication connection with the interactive server 202, and is configured to issue the control command to the interactive server 202 according to an operator instruction. The terminal 201 is further configured to display the data information transmitted by the interactive server 202.

The operator sets the operator instruction on the terminal, and the terminal uploads the execution of the operator to the acquisition apparatus to complete the acquisition of the image of the chip tray, then obtains the codes of chips in the image of the chip tray, and transmits the obtained information to the terminal stage by stage, so that the operator remotely controls the acquisition apparatus to acquire the codes of chips in the chip tray.

It is worth mentioning that the units involved in this embodiment are all logical units. In practical applications, a logical unit may be a physical unit, a part of a physical unit, or a combination of a plurality of physical units. Moreover, in order to highlight the innovative part of the present application, this embodiment does not introduce units that are not closely related to solving the technical problems proposed by the present application, but this does not indicate that there are no other units in this embodiment.

Since the above embodiment corresponds to this embodiment, this embodiment may be implemented in cooperation with the above embodiment. Relevant technical details mentioned in the above embodiment are still valid in this embodiment, and the technical effects that can be achieved in the above embodiment can also be achieved in this embodiment. In order to reduce repetition, details are not described herein again. Correspondingly, the relevant technical details mentioned in this embodiment may also be applied to the above embodiment.

Another embodiment of the present application relates to an acquisition method, including: a terminal receiving an operator instruction, and issuing a control command to an interactive server based on the operator instruction; the interactive server uploading the received control command to a storage database; the storage database updating data based on the control command, and transmitting the control command to a control converter; the control converter setting configuration information for an acquisition apparatus according to the control command; the acquisition apparatus acquiring an image of a chip tray according to the configuration information; the control converter obtaining data information from the image of the chip tray, and uploading the data information to the storage database; the storage database storing the data information; the interactive server searching corresponding data information in the storage database according to the control command, and transmitting the data information to the terminal; and the terminal displaying the data information transmitted by the interactive server.

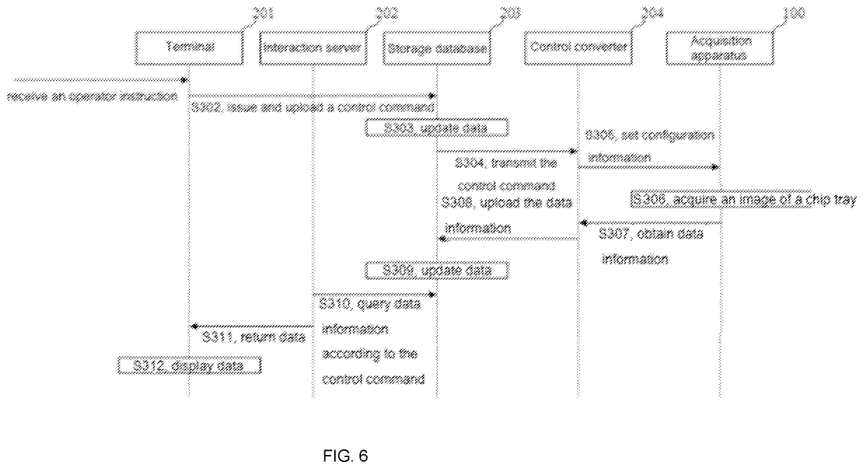

FIG. 6 is a schematic flowchart of the acquisition method provided by this embodiment. The acquisition method provided by this embodiment will be described in detail below in conjunction with the accompanying drawing. The parts that are the same as or corresponding to the above embodiment will not be described in detail below.

Referring to FIG. 6, the acquisition method involves a terminal 201, an interactive server 202, a storage database 203, a control converter 204, and an acquisition apparatus 100. The specific steps are as follows:

Step 301, an operator instruction is received.

The terminal 201 receives an operator instruction. Specifically, an operator operates on the terminal 201, and the terminal generates a corresponding control command according to the operation of the operator on the terminal 201.

Step 302, a control command is issued and uploaded.

The terminal 201 issues a control command to the interactive server 202 based on the operator instruction, and the interactive server 202 uploads the received control command to the storage database 203. Specifically, the terminal 201 issues the generated control command to the interactive server 202, and the interactive server 202 uploads the received control command to the storage database 203.

Step 303, data is updated.

The storage database 203 is updated based on the control command. Specifically, the storage database 203 updates data to add the received control command to the database.

Step 304, the control command is transmitted.

The storage database 203 transmits the control command to the control converter 204, and the storage database 203 transmits the control command to the control converter 204 after the data update is completed.

Step 305, configuration information is set.

The control converter 204 sets configuration information for the acquisition apparatus 100 according to the control command. Specifically, the control converter 204 analyzes the control command to obtain the configuration information of the acquisition apparatus 100, and completes the setting of the acquisition apparatus 100 according to the configuration information indicated by the control command.

Step 306, an image of the chip tray is acquired.

The acquisition apparatus 100 acquires an image of the chip tray according to the configuration information.

Step 307, data information is obtained.

The control converter 204 obtains data information from the image of the chip tray. Specifically, the control converter 204 receives the image of the chip tray acquired by the acquisition apparatus 100, and identifies the image of the chip tray to obtain chip codes in the image of the chip tray.

Step 308, the data information is uploaded.

The control converter 204 uploads the data information to the storage database 203. Specifically, after the control converter 204 obtains the chip codes in the image of the chip tray, it uploads the chip codes in the image of the chip tray to the storage database 203.

Step 309, data is updated.

The storage database 203 stores the data information. Specifically, the storage database 203 updates data to add the received chip codes in the image of the chip tray to the database.

Step 310, data information is queried according to the control command.

The interactive server 202 searches corresponding data information in the storage database 203 according to the control command. Specifically, the interactive server 202 continuously polls the storage database 203 until it finds the chip codes in the image of the chip tray corresponding to the control command from the storage database 203.

Step 311, data is returned.

The interactive server 202 transmits the data information to the terminal 201. Specifically, after obtaining the chip codes in the image of the chip tray corresponding to the control command, the interactive server 202 transmits the chip codes in the image of the chip tray to the terminal 201.

Step 312, the data is displayed.

The terminal 201 displays the data information transmitted by the interactive server 202. Specifically, the terminal 201 displays the chip codes in the image of the chip tray corresponding to the control command through a display panel.

The operator sets the operator instruction on the terminal, and the terminal uploads the execution of the operator to the acquisition apparatus to complete the acquisition of the image of the chip tray, then obtains the codes of chips in the image of the chip tray, and transmits the obtained information to the terminal stage by stage, so that the operator remotely controls the acquisition apparatus to acquire the codes of chips in the chip tray.

The division of the above various steps is only for clarity of description. When implemented, the steps can be combined into one step or some steps can be split into a plurality of steps, as long as they comprise the same logical relationship, they fall all within the protection scope of this patent. Insignificant modifications added or insignificant designs introduced to the process without changing the core design of the process all fall within the protection scope of this patent.

Since the above embodiment corresponds to this embodiment, this embodiment may be implemented in cooperation with the above embodiment. Relevant technical details mentioned in the above embodiment are still valid in this embodiment, and the technical effects that can be achieved in the above embodiment can also be achieved in this embodiment. In order to reduce repetition, details are not described herein again. Correspondingly, the relevant technical details mentioned in this embodiment may also be applied to the above embodiment.

A person of ordinary skill in the art can understand that the above embodiments are specific embodiments for implementing the present application, and in actual applications, various changes may be made in form and details without departing from the spirit and scope of the present application.

1. An acquisition apparatus, comprising:
a base and a core plate disposed on the base, the core plate being configurated to carry a chip tray;
a first support portion, the first support portion being disposed on the base and connected with a first camera assembly, and the first camera assembly being disposed above the core plate; and
a second support portion, the second support portion being disposed on the base and connected with a second camera assembly, and the second camera assembly being disposed above the core plate;
wherein the first camera assembly is configurated to capture an image of a first region of the chip tray, the second camera assembly is configurated to capture an image of a second region of the chip tray, and a sum of the first region and the second region covers an entire region of the chip tray.

2. The acquisition apparatus according to claim 1, wherein the first camera assembly and the second camera assembly are respectively located above intersections of two trisectors in a length direction of the core plate and a perpendicular bisector in a width direction of the core plate.

3. The acquisition apparatus according to claim 1, wherein in a direction perpendicular to a surface of the base, the first camera assembly and the second camera assembly are located at the same height, and the first camera assembly is 20 mm to 25 mm away from a top surface of the core plate.

4. The acquisition apparatus according to claim 1, wherein the first region comprises a first sub-region and a third sub-region, and the second region comprises a second sub-region and a fourth sub-region;
wherein the first sub-region and the second sub-region are: in a length direction of the core plate, and in two regions for dividing the core plate equally, the third sub-region is a part of the second sub-region close to the first sub-region, and the fourth sub-region is a part of the first sub-region close to the second sub-region.

5. The acquisition apparatus according to claim 1, further comprising: light-emitting assemblies located on the base and located on two sides of the core plate, wherein each light-emitting assembly is disposed parallel to an edge of one side of the core plate close to the light-emitting assembly.

6. The acquisition apparatus according to claim 5, further comprising: light-emitting assembly bases located on the base and configurated to carry the light-emitting assemblies, wherein the light-emitting assemblies are disposed on the light-emitting assembly bases.

7. The acquisition apparatus according to claim 6, wherein in a direction perpendicular to a surface of the base, a height of the light-emitting assembly base satisfies the following condition: an incident angle of the light-emitting assembly to an edge of one side of the core plate away from the light-emitting assembly is less than 60°.

8. The acquisition apparatus according to claim 6, wherein in a direction perpendicular to a surface of the base, a side of the light-emitting assembly base is provided with bayonets of different heights, the base is also fixed with clamping grooves tabled with the bayonets, and the bayonets and the clamping grooves are configurated to adjust height differences between the light-emitting assembly bases and the base according to a size of the core plate.

9. The acquisition apparatus according to claim 1, further comprising:
a support rod, disposed on the base;
the first support portion comprising a first support arm, and the second support portion comprising a second support arm;
the first support arm extending in a first direction from the support rod and being connected to the first camera assembly; and
the second support arm extending in a second direction from the support rod and being connected to the second camera assembly;
wherein an angle between the first direction and the second direction is greater than 0° and less than 180°.

10. The acquisition apparatus according to claim 9, wherein the support rod is movably disposed on the base to change horizontal positions of the first camera assembly and the second camera assembly.

11. The acquisition apparatus according to claim 1, further comprising: a positioning assembly, wherein the positioning assembly is fixed on the base and configurated to fix the core plate placed on the base.

12. The acquisition apparatus according to claim 11, wherein the positioning assembly comprises two L-shaped positioning portions arranged oppositely, the core plate is rectangular, and the L-shaped positioning portions are attached to two opposite corners of the core plate to fix the core plate.

13. The acquisition apparatus according to claim 12, wherein the base further comprises a plurality of discrete slots, and bottoms of the L-shaped positioning portions are also provided with pins that fit the slots.

14. An acquisition system, comprising: the acquisition apparatus according to claim 1, a control converter, a storage database, an interactive server and a terminal;
the acquisition apparatus is configured to acquire an image of the chip tray;
the control converter is in communication connection with the acquisition apparatus, and is configured to set configuration information for the acquisition apparatus according to a control command, obtain the image of the chip tray, obtain data information from the image of the chip tray, and upload the data information to the storage database;
the storage database is in communication connection with the control converter, and is configured to update data based on the control command, transmit the control command to the control converter, and store the data information;
the interactive server is in communication connection with the storage database, and is configured to upload the received control command to the storage database, search corresponding data information in the storage database based on the control command, and transmit the data information to the terminal; and
the terminal is in communication connection with the interactive server, and is configured to issue the control command to the interactive server based on an operator instruction and display the data information transmitted by the interactive server.

15. An acquisition method, comprising:
a terminal receiving an operator instruction, and issuing a control command to an interactive server based on the operator instruction;
the interactive server uploading the received control command to a storage database;
the storage database updating data based on the control command, and transmitting the control command to a control converter;
the control converter setting configuration information for an acquisition apparatus according to the control command;
the acquisition apparatus acquiring an image of a chip tray according to the configuration information;
the control converter obtaining data information from the image of the chip tray, and uploading the data information to the storage database;
the storage database storing the data information;
the interactive server searching corresponding data information in the storage database according to the control command, and transmitting the data information to the terminal; and
the terminal displaying the data information transmitted by the interactive server.

16. The acquisition apparatus according to claim 2, wherein in a direction perpendicular to a surface of the base, the first camera assembly and the second camera assembly are located at the same height, and the first camera assembly is 20 mm to 25 mm away from a top surface of the core plate.
